(19) United States
(12) Patent Application Publication
(10) Pub. No.: US 2010/0039634 A1
(43) Pub. Date: Feb. 18, 2010

(54) EXPOSURE APPARATUS FOR DISPLAY AND EXPOSING METHOD USING THE SAME

(75) Inventors: Hye-Ran You, Incheon (KR); Yoon-Sung Um, Yongin-si (KR); Ji-Won Sohn, Seoul (KR); Jun-Hyup Lee, Seoul (KR); Myeong-Ha Kye, Seoul (KR); Su-Han Woo, Asan-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/411,994

(22) Filed: Mar. 26, 2009

(30) Foreign Application Priority Data
Aug. 18, 2008 (KR) 10-2008-0080483

(51) Int. Cl. G03B 27/54; G03B 27/32

(52) U.S. Cl. 355/70; 355/77

(57) ABSTRACT

Provided is an exposure apparatus, including a plurality of exposure lamps and a luminance changing mechanism disposed between the exposure lamps and an exposure target. The luminance changing mechanism changes the location at which the exposure light generated from the exposure lamps reaches the exposure target by changing the direction in which the exposure light travels.

### CROSS-REFERENCE TO RELATED APPLICATION

This application claims priority from and the benefit of Korean Patent Application No. 10-2008-0080483, filed on Aug. 18, 2008, which is hereby incorporated by reference for all purposes as if fully set forth herein.

### BACKGROUND OF THE INVENTION

1. Field of the Invention

The present invention relates to an exposure apparatus and exposure method that are used to expose a substrate in the manufacture of a display substrate of a liquid crystal display or the like.

2. Discussion of the Background

The manufacture of a thin film transistor (TFT) substrate or color filter substrate of a liquid crystal display used as a display panel, a substrate for a plasma display panel, and a substrate for an organic EL (electroluminescence) display panel may be carried out by forming a pattern on a substrate by a photolithography technique using an exposure apparatus. An exposure apparatus irradiates exposure light onto a substrate coated with a photosensitive resin material (photoresist) and transfers a pattern of a mask onto the substrate.

Light sources that generate exposure light of the exposure apparatus may include lamps with a high pressure gas filled by a valve, such as mercury lamps, halogen lamps, and xenon lamps. These lamps should be cooled during use because of they generate heat and there is a risk that the valve will rupture when an excessively high temperature is reached. Further, if the liquid crystal display panel is large, a plurality of lamps may be used, and thus uniformity may deteriorate due to a difference in the luminance of light between intervals of the lamps.

### SUMMARY OF THE INVENTION

The present invention provides an exposure apparatus and exposure method that may provide for a uniform surface temperature of lamps and stabilized luminance of exposure light.

Additional features of the invention will be set forth in the description which follows, and in part will be apparent from the description, or may be learned by practice of the invention.

The present invention discloses an exposure apparatus including a plurality of exposure lamps and a luminance changing mechanism disposed between the exposure lamps and an exposure target. The luminance changing mechanism changes a location at which exposure light generated from the exposure lamps reaches the exposure target by changing the direction in which the exposure light generated travels.

The present invention also discloses an exposure method including generating an exposure light using a plurality of lamps, passing the exposure light through a luminance changing mechanism, and allowing the exposure light that passed through the luminance changing mechanism to reach an exposure target. The location at which exposure light generated from a specific position of the exposure lamps reaches the exposure target varies with time.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a layout of an exposure apparatus having water and an oscillator disposed between lamps and a panel according to one exemplary embodiment of the present invention.

FIG. 2 is a cross-sectional view showing the profile of luminance of a conventional exposure apparatus having a plurality of lamps.

FIG. 3 is a cross-sectional view taken along line A-A of the exposure apparatus of a plurality of lamps as shown in FIG. 1.

FIG. 4A is a cross-sectional view showing the lines of movement of light in the exposure apparatus having a water layer with no waves between the lamps and a panel.

FIG. 4B is a cross-sectional view showing the lines of movement of light when waves are produced in the water layer in the exposure apparatus having the water layer disposed between the lamps and the panel.

FIG. 5 is a conceptual view of an exposure apparatus using a slit mask according to another exemplary embodiment of the present invention.

FIG. 6A is a cross-sectional view showing a conventional exposure method using a slit mask.

FIG. 6B is a cross-sectional view showing the role of the slit mask is partial exposure in FIG. 6A.

FIG. 7 is a layout drawing of the slit mask used in FIG. 5.

FIG. 8 is a view showing a luminance profile before and after light of the lamps as shown in FIG. 5 passes through the slit mask.

FIG. 9 is a cross-sectional view taken along line C-C′ of the slit mask as shown in FIG. 7.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Generally, the luminance of exposure light changes depending on the surface temperature of a lamp. A specified surface temperature for the lamp may be set, and when an exposure treatment is carried out, the surface temperature of the lamp should be kept at the specified surface temperature in order to stabilize the luminance of the exposure light.

The amount of exposure light is proportional to the luminance and exposure time of exposure light. Recently, as substrates increase in size due to the trend toward large-screen display panels, there has been a demand for a light source of an exposure apparatus that has higher luminance. The higher the luminance of the light source, the higher the luminance of the exposure light and the shorter the exposure time, which may reduce tack time and improve throughput.

Further, because the amount of exposure light required for exposure is different according to the size of a substrate or the type of photoresist, conventionally, lamps have had to be replaced to change the luminance of the light source. Since time and labor are needed to replace the lamps, there has been a demand for a way to change the luminance of the light source without replacing the lamps.

To satisfy this demand, the luminance of a light source may be increased by utilizing a plurality of lamps as the light source to generate exposure light, and the luminance of the light source may be changed by switching between the lamps. However, it may be difficult to make the surface temperature of the lamps uniform and therefore, the luminance of the exposure light may not be stabilized. This is because part of the exposure light generated from each lamp is irradiated onto an adjacent lamp directly or by transmitting through a condensing mirror formed around each lamp, and a temperature gap is generated at a portion on which exposure light of the adjacent lamp is irradiated and at a portion on which no exposure light of the adjacent lamp is irradiated. In addition, it may be difficult to make the surface temperature of the lamps uniform also because heat generated from each lamp is transferred to an adjacent lamp, and a temperature gap is generated at a location close to the adjacent lamp and at a location far from the adjacent lamp.

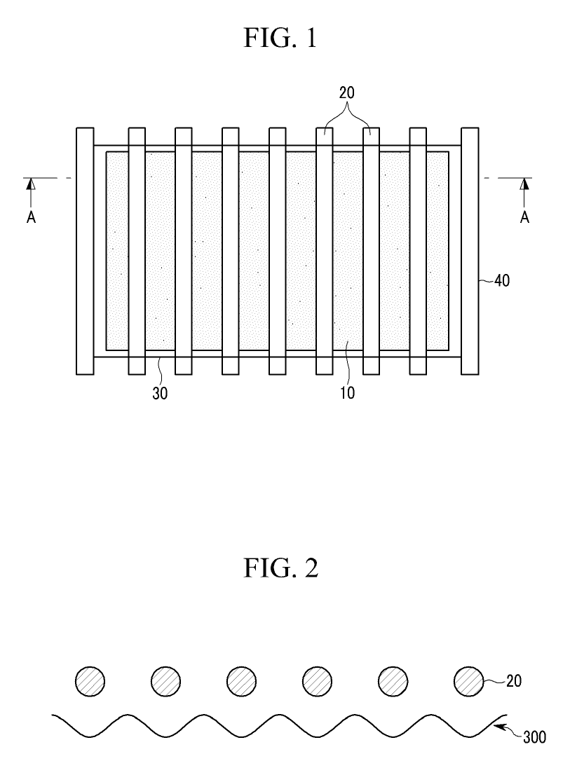

FIG. 1 is a layout drawing for showing an exposure apparatus according to one exemplary embodiment of the present invention.

FIG. 1 is a layout drawing showing an exposure apparatus having water and an oscillator disposed between lamps and a panel.

Here, there may be a plurality of lamps 20 to produce a desired luminance of light depending on the overall size of the panel.

The panel 10 may be a liquid crystal display that has a thin film transistor (TFT) formed on a first substrate and is filled with a liquid crystal containing monomers between the first substrate and a second substrate.

A water layer 30 is formed at an appropriate point between the plurality of lamps 20 and the liquid crystal panel 10, and the water layer 30 is formed wide enough to have a width and length similar to the plane area of the liquid crystal panel 10. However, the water layer 30 may be formed to have a width and length that are different from the plane area of the liquid crystal panel 10.

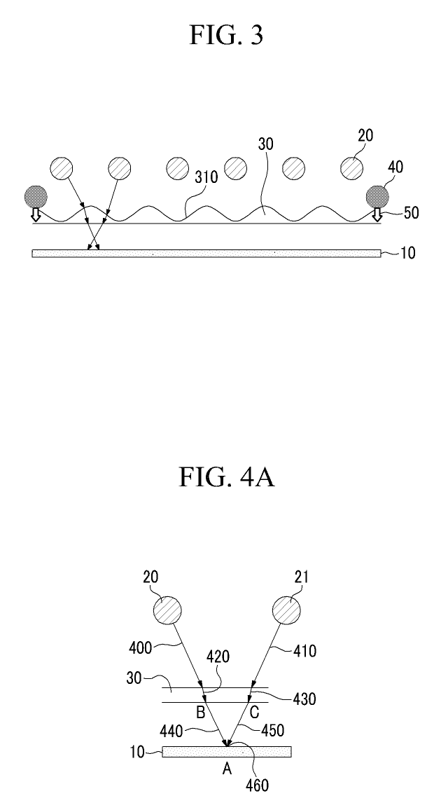

In addition, referring to the luminance profile of non-filtered light from the plurality of lamps as shown in FIG. 2, if the water layer 30 includes only water, it serves to cool down the heat generated by the lamp and to vary the luminance profile of light. Thus, an element to form waves in the water layer 30 may be used, for example an oscillator 40, which is shown in FIG. 3. It is appropriate for the oscillator 40 to be disposed at both sides of an edge portion of the water layer 30 that is formed to be the same size as the panel 10. However, the oscillator 40 may be positioned at other locations, such as at the center of the water layer 30.

The movement direction 50 of the oscillator may be an up-and-down direction, however, the oscillator 40 may oscillate in various directions that are capable of generating waves of a similar waveform.

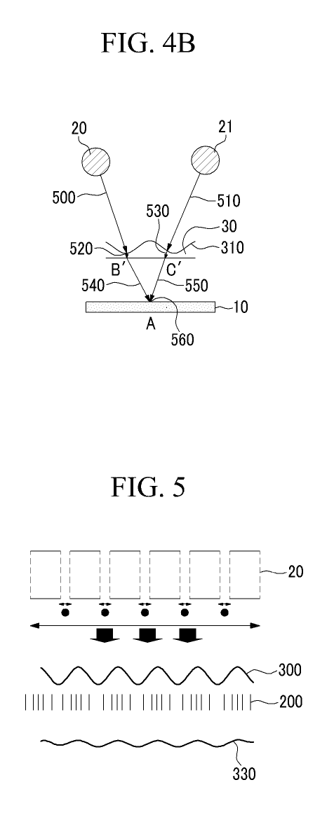

FIG. 4A and FIG. 4B indicate light with arrows with regard to the direction and position of travel of light from lamps 20 and 21 to the panel 10 in the cases when a wave is produced in the water layer 30 by the oscillator 40 (FIG. 4B) and when a wave is not produced (FIG. 4A). The direction and size of the arrows may vary depending on the position of refraction of the light (400-450, 500-550).

As shown in FIG. 4A, the light 400 and 410 from the lamps 20 and 21 is refracted upon meeting the water layer 30, and the light 420 and 430 traveling from the water layer 30 reaches the air, is refracted in a different direction, and becomes light 440 and 450 traveling toward the panel 10. A point 460 at which the light 440 and 450 meet upon reaching the panel 10 when there are no waves in the water layer 30 may always be the same.

However, in FIG. 4B, the light 500 and 510 from the lamps 20 and 21 meet an upper surface 310 of the water layer 30, which is constantly changing shape due to the waves generated by the oscillator 40, and hence the angle at which the light 500 and 510 and the upper surface 310 of the water layer 30 meet may change every moment, thereby varying the positions at which the light 540 and 550 reaches the panel 10. That is to say, the upper surface 310 of the water layer 30 has peaks and valleys due to the waves. If the oscillator 40 varies the amplitude and frequency of the waves, the direction of travel of the light 520 and 530 from the lamps 20 and 21 and refracted upon entering the upper surface 310 of the water layer 30 may vary according to which of the peaks and valleys of the upper surface 310 of the water layer 30 the light 520 and 530 enters.

Therefore, in FIG. 4A, positions B and C at which the light passing through the water layer 30 exits out of the air upon refraction are always almost the same, and thus the point 460 at which the light generated by the lamps 20 and 21 reaches and causes constructive or destructive interference is always almost the same. That is, as shown in FIG. 2, the difference between the peaks and valleys of the luminance profile 300 of light may vary greatly according to the position of the surface of the panel 10.

On the other hand, in FIG. 4B, points B′ and C′ at which the light passing through the water layer 30 and the air meet due to the water formed in the water layer 30 continue to change as the shape of the upper surface 310 of the water layer 30 changes. As a result, the position of a point 560 at which the light 540 and 550 passing through B′ and C′ and reaching the panel 10 causes constructive or destructive interference varies as the oscillator 40 produces waves in the water layer 30. As stated above, when the position 560 that causes constructive or destructive interference varies with time, constructive interference and destructive interference may co-exist throughout the entire panel 10. Thus, if the luminance of light irradiated from the panel 10 is averaged for a specific time, a uniform luminance profile may be obtained over the entire panel 10. Such a luminance profile undergoes a reduction in luminance difference according to position like the luminance profile 330 of light that passes through a slit mask, as shown in FIG. 5. In addition, the luminance profile of light may be made more uniform by adjusting the amplitude and frequency of the oscillator 40.

Furthermore, the aforementioned FIG. 5 shows another exemplary embodiment of the present invention.

In the exemplary embodiment of FIG. 5, unlike the previous exemplary embodiment utilizing waves of water, the intensity of light from the lamps is adjusted using a slit mask. As shown in FIG. 5, a slit mask 200 is positioned under the lamps 20 to pass light therethrough.

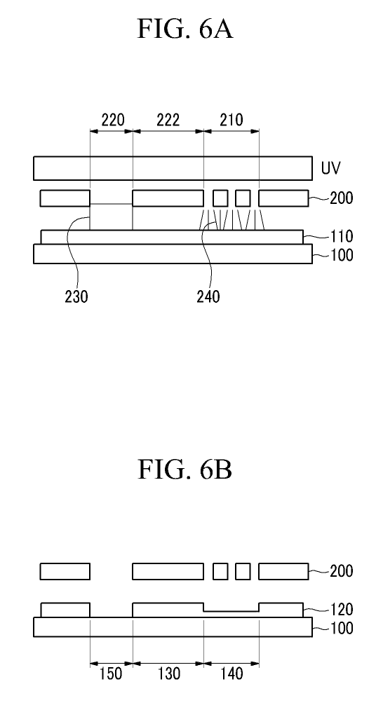

FIG. 6A shows the effect of a general slit mask 200 on a photoresist 110 over the substrate. In FIG. 6A, the slit mask 200 includes an opaque region 222, a transparent region 220 and a slit region 210 including an opaque layer having a plurality of slits through which light passes. When UV (ultraviolet) rays are irradiated over the slit mask 200, the amount of UV rays 230 that pass through the transparent region 220 of the slit mask 200 is relatively larger than the amount of UV rays 240 that pass through the slit region 210. Accordingly, the amount of UV rays irradiated to the photoresist 110 formed on the substrate 100 is greater at a position corresponding to the transparent region 220, compared to a position corresponding to the slit region 210.

FIG. 6B shows a state of the developed photoresist 120 after being exposed to the UV rays 230 and 240 that pass through the slit mask 200. As shown in FIG. 6B, a portion 150 of the developed photoresist 120 exposed to the UV rays 230 that pass through the transparent region 220 of the slit mask 200 is eliminated on the substrate 100, and a portion 130 of the developed photoresist 120 that is not exposed to UV rays due to the opaque region 222 of the slit mask 200 is left as it is. A portion 140 of the developed photoresist 120 exposed to the UV rays 240 that pass through the slit region 210 of the slit mask 200 may become thinner than it was originally. The thickness of the portion 140 of the developed photoresist 120 formed by exposure through the slit region 210 is closely related to the exposure time and intensity of the UV rays 240. Thus, the exposure time and intensity of UV rays 240 may be properly adjusted to freely form a desired thickness.

Referring to FIG. 6A and FIG. 6B, as explained above, the intensity of light generated by a UV light source may be adjusted using the slit mask 200. Further, the intensity of light may be adjusted so as to be continuously varied by adjusting the width and interval of the slits.

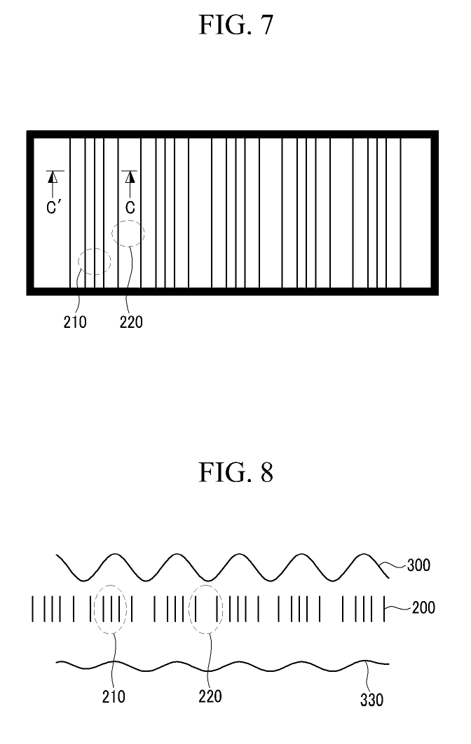

FIG. 7 is a layout drawing of the slit mask 200 used in the exposure apparatus according to another exemplary embodiment of the present invention.

When describing the slit mask 200 of the exposure apparatus according to this exemplary embodiment in detail, the overall size of the slit mask 200 is almost the same as the size of the panel 10. This is because the slits of the slit mask 200 should have a sufficient size to affect the entire panel 10 in order to make the luminance of a light source uniformly reach every part of the liquid crystal panel 10 through the plurality of lamps 20.

The slits of the slit mask 200 of FIG. 7 are formed by disposing opaque lines at predetermined intervals, and have a region 210 in which opaque lines are densely formed and a region 220 in which opaque lines are sparsely formed. That is to say, the slit mask 200 has a portion 210 in which the width of the slits is small due to narrow intervals between the opaque lines and a portion 220 in which the width of the slits is large due to wide intervals between the opaque lines. The width of the slits may gradually decrease and increase in a repetitive manner. Alternatively, the intervals between the slits may vary while the width of the slits is constant. For example, the intervals between the slits may gradually increase and decrease in a repetitive manner.

FIG. 8 is a view showing the profiles 300 and 330 of light generated by the lamps 20 shown in FIG. 5 before and after passing through the slit mask 200, respectively, as shown in FIG. 7.

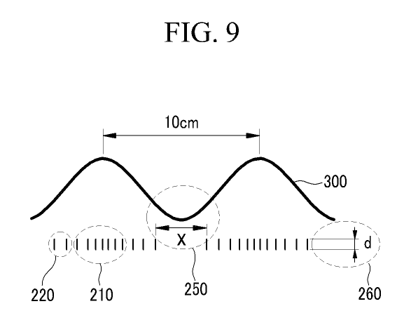

In FIG. 9, d indicates the thickness 260 of the opaque lines forming the slits, x indicates the largest interval 250 among the intervals between the opaque lines, and d and x have a relationship of x>d in which there is no loss of UV rays when x is much greater than d.

In addition, the average distance between adjacent lamps may about 10 cm, and the proper height d of the slits may be about several mm, e.g., 1 mm. But the height and interval of the slits may be adjusted within an ideal range according to the type and intensity of UV rays.

Although the above described exemplary embodiment uses slits to adjust the amount of exposure, a grating quartz or the like may be used instead of the slits.

By using the exposure apparatus or exposure method according to exemplary embodiments of the present invention, the luminance of exposure light may be stabilized because the uniformity of luminance may be increased and the demand for luminance change may be met, which may enable the manufacture of a high-quality substrate within a short tack time.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An exposure apparatus, comprising:
a plurality of exposure lamps; and
a luminance changing mechanism disposed between the exposure lamps and an exposure target,
wherein the luminance changing mechanism changes a location at which exposure light generated from the exposure lamps reaches the exposure target by changing the direction in which the exposure light travels.

2. The exposure apparatus of claim 1, wherein
the luminance changing mechanism comprises water and an oscillator to produce waves on a surface of the water.

3. The exposure apparatus of claim 2, wherein
the oscillator performs vertical movement with respect to the surface of the water.

4. The exposure apparatus of claim 3, wherein
the oscillator performs horizontal movement with respect to the surface of the water.

5. The exposure apparatus of claim 2, wherein
oscillation of the oscillator varies to change the waves formed on the surface of the water.

6. The exposure apparatus of claim 5, wherein
the waves formed on the surface of the water are irregular.

7. The exposure apparatus of claim 1, wherein
a plane area of the luminance changing mechanism is greater than or equal to a plane area of the exposure target.

8. The exposure apparatus of claim 1, wherein
the luminance changing mechanism comprises grating quartz.

9. The exposure apparatus of claim 1, wherein
the luminance changing mechanism comprises a slit mask.

10. The exposure apparatus of claim 9, wherein
the slit mask comprises an opaque portion and a transparent portion.

11. The exposure apparatus of claim 10, wherein
a slit width of the slit mask gradually decreases and increases in a repetitive manner.

12. The exposure apparatus of claim 11, wherein
a largest slit width is greater than a thickness of an opaque layer that forms the slits of the slit mask.

13. The exposure apparatus of claim 10, wherein
a interval between the slit of the slit mask gradually decreases and increases in a repetitive manner.

14. An exposure method, comprising:
generating an exposure light by a plurality of exposure lamps;
passing the exposure light through a luminance changing mechanism; and
allowing the exposure light that has passed through the luminance changing mechanism to reach an exposure target,
wherein a location at which exposure light produced from a specific position of the exposure lamps reaches the exposure target varies with time.

15. The exposure method of claim 14, wherein
the luminance changing mechanism comprises water and an oscillator to produce waves on a surface of the water.

16. The exposure method of claim 15, wherein
the oscillator forms waves on the surface of the water by oscillating in a vertical direction or a horizontal direction with respect to the surface of the water.

17. The exposure method of claim 16, wherein
at least one of an amplitude and a frequency of the oscillator varies.

18. The exposure method of claim 14, wherein
the luminance changing mechanism comprises a slit mask.

19. The exposure method of claim 18, wherein
a slit width of the slit mask decreases and increases in a repetitive manner.

20. The exposure method of claim 18, wherein
a interval between the slit of the slit mask decreases and increases in a repetitive manner.

21. The exposure method of claim 18, wherein
the exposure target is a liquid crystal display panel, and the exposure light polymerizes monomers in the liquid crystal display panel.
